(19) United States
(12) Patent Application Publication
(10) Pub. No.: US 2011/0050356 A1
(43) Pub. Date: Mar. 3, 2011

(54) WAVEGUIDE CONVERTER AND MANUFACTURING METHOD FOR THE SAME

(75) Inventors: Satoshi NAKAMURA, Kawasaki (JP); Yoji Ohashi, Kawasaki (JP); Toshihiro Shimura, Kawasaki (JP)

(73) Assignee: FUJITSU LIMITED, Kawasaki-shi (JP)

(21) Appl. No.: 12/874,649

(22) Filed: Sep. 2, 2010

(30) Foreign Application Priority Data
Sep. 3, 2009 (JP) 2009-204115

(51) Int. Cl. H01P 5/107

(52) U.S. Cl. 333/26

(57) ABSTRACT

A waveguide converter includes a waveguide configured with an opening, a patch disposed inside the opening of the waveguide, a first ground conductor provided substantially along the opening of the waveguide and a port that opens in a side surface of the waveguide through which a signal line connected to the patch extends.

### CROSS-REFERENCE TO RELATED APPLICATIONS

This application is based upon and claims the benefit of priority of the prior Japanese Patent Application No. 2009-204115, filed on Sep. 3, 2009, the entire contents of which are incorporated herein by reference.

### FIELD

The embodiments discussed herein are related to a conversion structure that performs signal conversion for a substrate-side line in a high-frequency band and are related to, for example, a waveguide converter that performs signal conversion between a substrate-side line and a waveguide and a manufacturing method for the waveguide converter.

### BACKGROUND

In order to transmit a signal between a transmission circuit or a reception circuit and an antenna in a short-wavelength band (such as, e.g., a millimeter-wave band used for automotive radars), a hollow waveguide is interposed between the transmission circuit or the reception circuit and the antenna. In the signal transmission in which the waveguide is used, a waveguide converter is used as signal conversion mechanism.

For the waveguide converter, an input/output coupling structure for a dielectric waveguide is known (see Japanese Laid-open Patent Publication No. 2005-142884, for example). In the input/output coupling structure, a first conductor pattern is provided on a printed circuit board, a second conductor pattern is provided on a dielectric waveguide to cover the first conductor pattern, and the first and second conductor patterns are disposed opposite each other. In the input/output coupling structure, a microstrip line is provided on the printed circuit board, and the first conductor pattern is formed at a terminal portion of the microstrip line. A conductor wall or a spacer is provided to surround the first conductor pattern. The dielectric waveguide is mounted on the printed circuit board to cover the first conductor pattern such that the second conductor pattern formed on the dielectric waveguide and the first conductor pattern on the printed circuit board are disposed opposite each other.

A known technique for providing an interconnection between RF (radio frequency) printed circuit boards is to arrange a waveguide transmission line to connect between the RF printed circuit boards. In the known technique, each RF printed circuit board is integrally provided with a waveguide transmission/reception section (see Japanese Laid-open Patent Publication No. 2006-191077, for example).

A known high-frequency line-waveguide converter includes a dielectric layer, a line conductor disposed on the upper surface of the dielectric layer, and a high-frequency line disposed on the same surface to surround a part of the line conductor (see Japanese Laid-open Patent Publication No. 2005-286435, for example). In the high-frequency line-waveguide converter, the dielectric layer is configured to have a thickness that is smaller than one-fourth a wavelength λ of a high-frequency signal transmitted through the high-frequency line. In addition, a patch conductor is formed directly below one end of the ground conductor on the lower surface of the dielectric layer.

### SUMMARY

According to an aspect of the embodiments, a waveguide converter includes a waveguide configured with an opening, a patch disposed inside the opening of the waveguide, a first ground conductor provided substantially along the opening of the waveguide and a port that opens in a side surface of the waveguide through which a signal line connected to the patch extends.

The object and advantages of the embodiments will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating an exemplary waveguide converter according to a first embodiment;

FIG. 2 illustrates the waveguide converter as seen from a port portion side;

FIG. 3 illustrates the waveguide converter as seen from a direction orthogonal to the port portion side;

FIG. 4 is a perspective view illustrating the waveguide converter with a waveguide and a circuit substrate separated from each other;

FIG. 5 illustrates the waveguide converter as seen from a waveguide side with the port portion cut away;

FIG. 6 illustrates the details of a patch conductor, opening portions of the waveguide and a ground conductor, and the port portion;

FIG. 7 is a cross-sectional view taken along the line VII-VII of FIG. 5;

FIG. 8 is a cross-sectional view taken along the line VIII-VIII of FIG. 5;

FIG. 9 is a cross-sectional view taken along the line IX-IX of FIG. 5;

FIG. 10 is a cross-sectional view taken along the line X-X of FIG. 5;

FIG. 11 is a cross-sectional view taken along the line XI-XI of FIG. 5;

FIG. 12 is a cross-sectional view taken along the line XII-XII of FIG. 5;

FIG. 13 is a cross-sectional view taken along the line XIII-XIII of FIG. 5;

FIG. 14 illustrates a ground via;

FIG. 15 is a flowchart illustrating an exemplary manufacturing method for the waveguide converter;

FIG. 16 is an exploded perspective view illustrating an exemplary waveguide converter according to a second embodiment;

FIG. 17 illustrates a ground via;

FIG. 18 is an exploded perspective view illustrating an exemplary waveguide converter according to a third embodiment;

FIG. 19 illustrates the waveguide converter as seen from a waveguide side with the port portion cut away;

FIG. 20 illustrates an exemplary waveguide converter according to a fourth embodiment;

FIG. 21 illustrates an exemplary waveguide converter according to a fifth embodiment;

FIG. 22 illustrates an exemplary waveguide converter according to a sixth embodiment;

FIG. 23 illustrates an exemplary waveguide converter according to a seventh embodiment;

FIG. 24 is a perspective view illustrating an exemplary waveguide converter according to an eighth embodiment;

FIG. 25 illustrates an exemplary radar device according to a ninth embodiment;

FIG. 26 is a perspective view illustrating the exemplary radar device with an antenna partially cut away; and

FIG. 27 illustrates a waveguide converter used in simulation.

### DESCRIPTION OF EMBODIMENTS

In a waveguide converter, a semiconductor circuit chip is mounted, or a passive circuit is formed, on an insulated substrate. In the waveguide converter, a signal is converted and guided to a waveguide, or a signal guided from the waveguide is converted. A substrate made of ceramics may be used as the insulated substrate. While a ceramic substrate may offer a high pattern accuracy, it is expensive.

In order to promote cost reduction, it is conceivable to use a substrate made of a material other than ceramics, such as a resin, for example. However, while the resin substrate is inexpensive, it may offer a low pattern accuracy compared to the ceramic substrate, and therefore may result in significant positional (dimensional) variations caused in or during manufacture.

In view of the above, a first object of the present disclosure is to provide a waveguide converter that maintains the pattern accuracy and enhances the product accuracy without being affected by the substrate material used. Affected herein refers to being noticeably and/or significantly affected.

A second object of the present disclosure is to provide a waveguide converter with a structure that allows the use of an inexpensive substrate material such as a resin without degrading the pattern accuracy and that resists positional (dimensional) variations caused in or during manufacture.

In order to achieve the foregoing object, the present disclosure provides a waveguide converter that performs signal conversion for a substrate-side line. The waveguide converter includes, for example, a waveguide portion, a patch, a ground conductor portion, and a port portion. The waveguide portion may be formed by a waveguide. The patch is disposed inside an opening of the waveguide portion. The ground conductor portion is provided along the opening of the waveguide portion. The port portion opens in a side surface of the waveguide portion, and serves as a mechanism for leading out a signal line connected to the patch from the waveguide portion. According to such a configuration, it is possible to maintain the pattern accuracy and enhance the product accuracy without being affected by the substrate material used.

In order to achieve the foregoing object, the present disclosure also provides a manufacturing method for a waveguide converter that performs signal conversion for a substrate-side line. The manufacturing method for a waveguide converter includes: forming a waveguide portion including a port portion; forming a substrate portion with a ground conductor portion, a patch, and a signal line; and mounting the waveguide portion on the substrate portion.

The waveguide converter according to the present disclosure has a configuration in which the ground conductor portion which surrounds the patch is disposed inside the opening of the waveguide portion, and the signal line for the patch is led out from a side surface of the waveguide portion. Thus, it is possible to obtain stable conversion characteristics that are not affected by positional or dimensional variations between the opening of the waveguide portion and the patch.

According to the waveguide converter of the present disclosure, stable signal conversion and propagation modes can be obtained even if the ground conductor portion is provided on the substrate portion formed by a resin substrate which offers a low pattern accuracy compared to a ceramic substrate.

In the waveguide converter according to the present disclosure, the signal line is led out from a side surface of the waveguide portion. Thus, it is possible to prevent a waveguide mode from leaking out by using an opening size to prevent leakage of a waveguide mode.

### First Embodiment

According to a first embodiment, a ground conductor surrounding a patch overreaches into an opening of a waveguide, and a signal line for the patch is led out from a side surface of the waveguide by cutting away a part of the waveguide, achieving stable conversion characteristics that are not affected by the positional accuracy.

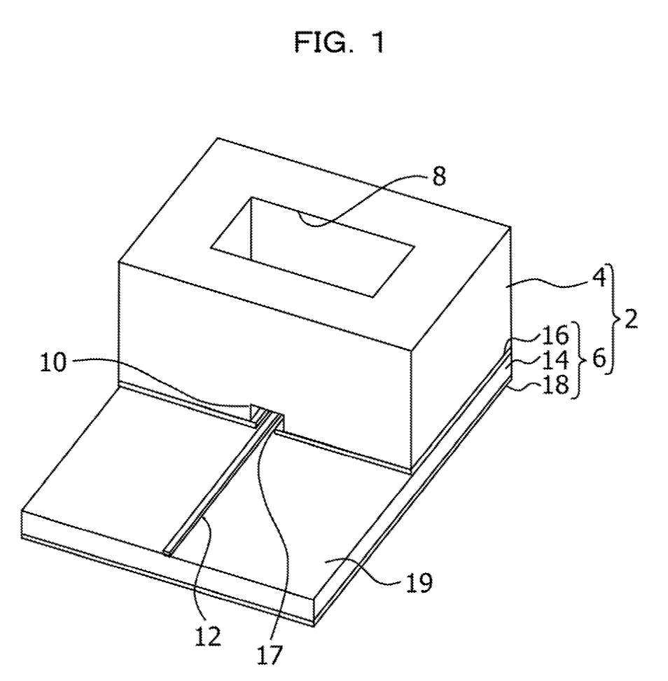

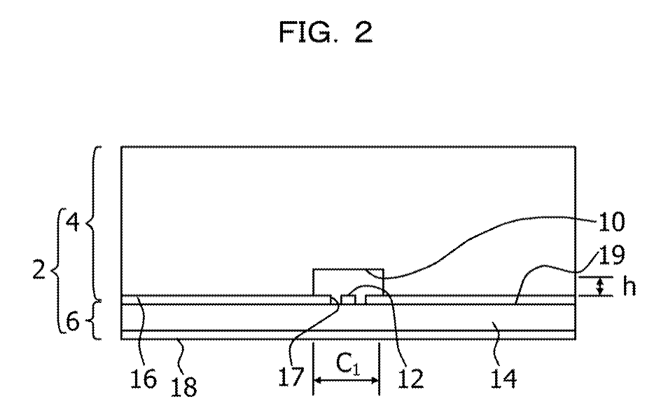

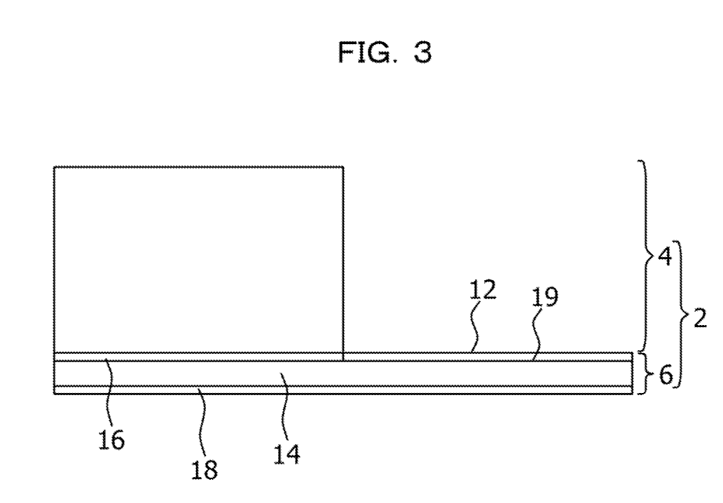

The first embodiment will be described with reference to FIGS. 1, 2, and 3. FIG. 1 illustrates an exemplary configuration of a waveguide converter. FIG. 2 illustrates the waveguide converter as seen from a port portion side, and FIG. 3 illustrates the waveguide converter as seen from a direction orthogonal to the port portion side (when the port portion side is defined as a front side, FIGS. 2 and 3 are a front view and a left side view, respectively, of the waveguide converter). The configuration illustrated in FIGS. 1, 2, and 3 is exemplary, and the present invention is not limited to such a configuration.

A waveguide converter 2 is a signal conversion mechanism coupled to a waveguide to perform signal conversion. As illustrated in FIGS. 1, 2, and 3, the waveguide converter 2 includes a waveguide 4 and a circuit substrate 6. The waveguide 4 is an example of a waveguide portion, and forms a transmission line through which a radio wave is transmitted. The waveguide 4 may be a rectangular pipe formed from a conductor, and includes a hollow portion 8. That is, the hollow portion 8 of the waveguide 4 is surrounded by a conductor, and substantially forms a transmission line or a waveguide path. The waveguide 4 may be provided on the upper surface of the circuit substrate 6 with an opening portion of the hollow portion 8 coupled to the circuit substrate 6. In the embodiment, the waveguide 4 is formed from a metal material with a uniform thickness. The waveguide 4 may be formed from a conductor material as described above, or may be formed by providing a conductor layer on a rectangular tube formed from a resin.

A port portion 10 is formed in a side surface of the waveguide 4. The port portion 10 is a mechanism for leading out a signal line 12 from the inside of the waveguide 4. The port portion 10 is a hollow that communicates the hollow portion 8 of the waveguide 4 with the side surface of the waveguide 4. As shown in FIGS. 1 and 2, the port portion 10 is a rectangular notch formed along and above the upper surface of the circuit substrate 6. The signal line 12 is an exemplary high-frequency line provided on the circuit substrate 6, and formed by a microstrip line, for example. A gap portion 17 is formed in a ground conductor 16 of the circuit substrate 6 to lead out the signal line 12 from the port portion 10.

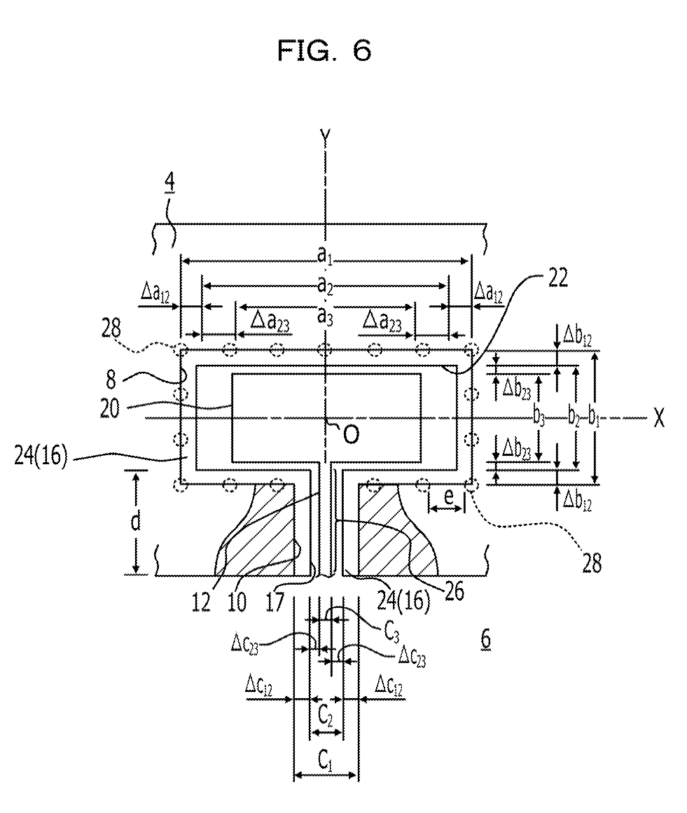

When the opening width and the opening height of the port portion 10 are defined as c₁ (FIG. 6) and h, respectively, as illustrated in FIG. 2, the opening width c₁ and the opening height h are set to be sufficiently smaller than half (=λ/2) a wavelength λ of a frequency of use f (λ/2>c₁ and λ/2>h). With λ/2>c₁ and λ/2>h, it is possible to prevent a waveguide mode propagating through the hollow portion 8 of the waveguide 4 from leaking out from the port portion 10.

The circuit substrate 6 is an example of the substrate portion according to the present disclosure. The circuit substrate 6 includes an insulated substrate 14, ground conductor 16, and second ground conductor 18. The insulated substrate 14 may have a square shape, for example. The ground conductor 16 discussed above is provided on one surface (for example, upper surface) of the insulated substrate 14 and serves as a first ground conductor. A second ground conductor 18 is provided on the other surface (for example, the lower surface) of the insulated substrate 14. The ground conductor 16 is an example of the ground conductor portion according to the present disclosure. An exposed surface portion 19 is provided adjacent to the ground conductor 16. The exposed surface portion 19 is a surface portion of the insulated substrate 14 where the ground conductor 16 is not formed and where the bare insulated substrate 14 is exposed.

The insulated substrate 14 may be formed in the shape of a flat plate with a uniform thickness. The insulated substrate 14 may be formed from an insulating material, specifically a synthesized resin such as, a Bakelite or ceramics, for example. The ground conductor 16 is a conductor layer with a uniform thickness provided on the upper surface of the insulated substrate 14. In the embodiment, the ground conductor 16 conforms to the end-surface shape of the waveguide 4. The ground conductor 18 is a conductor layer with a uniform thickness provided on the lower surface of the insulated substrate 14. In the embodiment, the ground conductor 18 is in the shape of a flat surface conforming to the shape of the insulated substrate 14 14. That is, the ground conductor 16 has a smaller surface area than the ground conductor 18, and the ground conductors 16 and 18 are two flat plates extending in parallel to each other and sandwiching the insulated substrate 14.

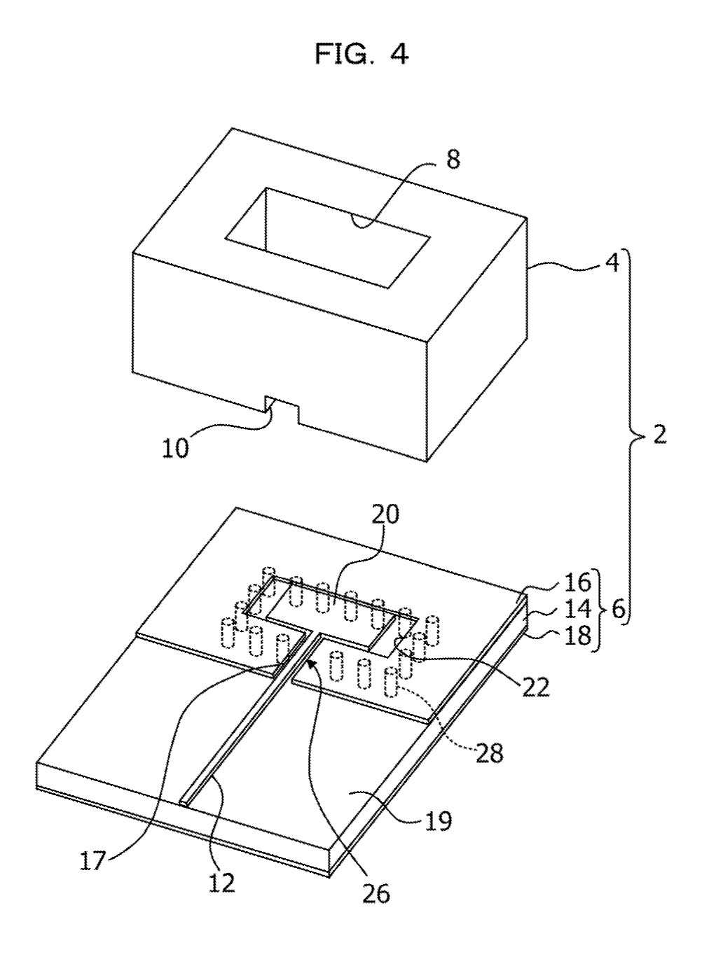

Next, the circuit substrate 6 will be described with reference to FIG. 4. FIG. 4 is an exploded perspective view illustrating the waveguide and the circuit substrate separated from each other. The configuration illustrated in FIG. 4 is exemplary, and the present invention is not limited to such a configuration. Components in FIG. 4 that are the same as those in FIG. 1 are denoted by the same reference numerals.

A patch conductor 20 is provided on the circuit substrate 6. The patch conductor 20 is a mechanism for electromagnetic coupling with the waveguide 4 that radiates a signal (radio wave) from the signal line 12 to the waveguide 4 or receives a signal from the waveguide 4. The patch conductor 20 is a conductor layer that is provided on the insulated substrate 14 exposed from the circuit substrate 6. The patch conductor 20 has a smaller area than the hollow portion 8 of the waveguide 4. In the embodiment, the patch conductor 20 has a rectangular shape that is analogous to the shape of the hollow portion 8 of the waveguide 4. The patch conductor 20 is provided inside the opening of the hollow portion 8 of the waveguide 4. The signal line 12 discussed above is connected to the patch conductor 20. The patch conductor 20 and the signal line 12 are formed on the same surface of the insulated substrate 14, as well as the ground conductor 16.

An opening portion 22 is formed in the ground conductor 16 of the circuit substrate 6 to expose the insulated substrate 14. The patch conductor 20 discussed above is formed inside the opening portion 22. The gap portion 17 discussed above is a mechanism for allowing the signal line 12 discussed above to pass therethrough. A uniform gap for insulation is provided between the ground conductor 16 and the signal line 12. Thus, a portion of the signal line 12 that passes through the waveguide 4 forms a coplanar line 26.

The ground conductor 16 and the ground conductor 18 are coupled to each other by a plurality of ground vias 28 to be electrically connected to each other. The ground vias 28 are an example of a single or a plurality of connection portions that connect the ground conductor 16 and the ground conductor 18. The ground vias 28 are not formed under the coplanar line 26.

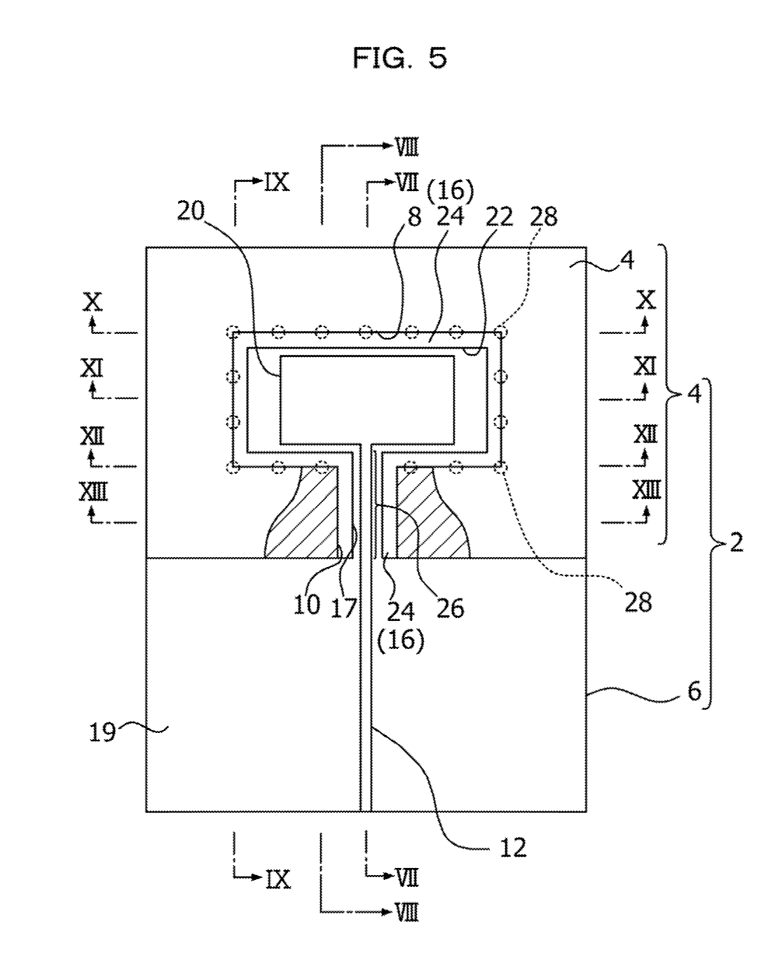

Next, the shape and the arrangement of the waveguide 4, the ground conductor 16, and the patch conductor 20 will be described with reference to FIGS. 5 and 6. FIG. 5 illustrates the waveguide converter as seen from the upper-surface side (waveguide side) with the port portion cut away. FIG. 6 illustrates the details of the patch conductor, the opening portions of the waveguide and the ground conductor, and the port portion. The configuration illustrated in FIGS. 5 and 6 is exemplary, and the present invention is not limited to such a configuration. Components in FIGS. 5 and 6 that are the same as those in FIGS. 1 and 4 are denoted by the same reference numerals.

As illustrated in FIG. 5, the waveguide 4 is provided on the upper surface of the ground conductor 16 of the circuit substrate 6. The patch conductor 20 is disposed inside the opening of the hollow portion 8 of the waveguide 4. The ground conductor 16 is provided along the opening of the hollow portion 8 of the waveguide 4. That is, the opening portion 22 of the ground conductor 16, which is disposed to surround the patch conductor 20, is configured to have an opening that is analogous to and smaller than the opening of the hollow portion 8 of the waveguide 4. Thus, an overreaching portion 24 that peripherally surrounds the patch conductor 20 is formed inside the opening of the hollow portion 8 of the waveguide 4. That is, the overreaching portion 24 of the ground conductor 16 surrounds the patch conductor 20. In addition, the plurality of ground vias 28 that connect the ground conductors 16 and 18 are disposed along the periphery of the hollow portion 8 of the waveguide 4. The plurality of ground vias 28 surround the opening portion 22 of the ground conductor 16 and the opening of the waveguide 4.

Thus, as illustrated in FIG. 6, when the long-side length and the short-side length of the hollow portion 8 of the waveguide 4 are defined as a₁ and b₁, respectively, the long-side length and the short-side length of the opening portion 22 of the ground conductor 16 are defined as a₂ and b₂, respectively, and the long-side length and the short-side length of the patch conductor 20 are defined as a₃ and b₃, respectively, the relationship a₁>a₂>a₃ and b₁>b₂>b₃ is established.

When the widths of the overreaching portion 24 of the ground conductor 16 with respect to the hollow portion 8 of the waveguide 4 are defined as Δa₁₂ and Δb₁₂, the following formulas are satisfied:

Δa₁₂=(a₁−a₂)/2 (1)

Δb₁₂=(b₁−b₂)/2 (2)

In this case, X-axis and Y-axis that intersect at center axis O corresponding to the center of the hollow portion 8 of the waveguide 4 are defined, and it is assumed that the left and right widths Δa₁₂ are the same as each other and the upper and lower widths Δb₁₂ are the same as each other. However, the left and right widths Δa₁₂ may be different from each other, and the upper and lower widths Δb₁₂ may be different from each other.

When the width of gaps between the patch conductor 20 and the overreaching portion 24 of the ground conductor 16 are defined as Δa₂₃ and Δb₂₃, the following formulas are satisfied:

Δa₂₃=(a₂−a₃)/2 (3)

Δb₂₃=(b₂−b₃)/2 (4)

In this case, it is assumed that the left and right widths Δa₂₃ are the same as each other and the upper and lower widths Δb₂₃ are the same as each other on X-axis and Y-axis that intersect at center axis O. However, the left and right widths Δa₂₃ may be different from each other, and the upper and lower widths Δb₂₃ may be different from each other.

When the width of the port portion 10 of the waveguide 4 is defined as c₁, the width of the gap portion 17 of the ground conductor 16 in the port portion 10 is defined as c₂, and the width of the signal line 12 is defined as c₃, the relationship c₁>c₂>c₃ is established. When the width of the overreaching portion 24 of the ground conductor 16 in the port portion 10 is defined as Δc₁₂, the following formula is satisfied:

Δc₁₂=(cᵢ−c₂)/2 (5)

When the width of the gap between the signal line 12 and the overreaching portion 24 of the ground conductor 16 is defined as Δc₂₃, the following formula is satisfied:

Δc₂₃=(c₂−c₃)/2 (6)

In FIG. 6, d corresponds to the length of the coplanar line 26.

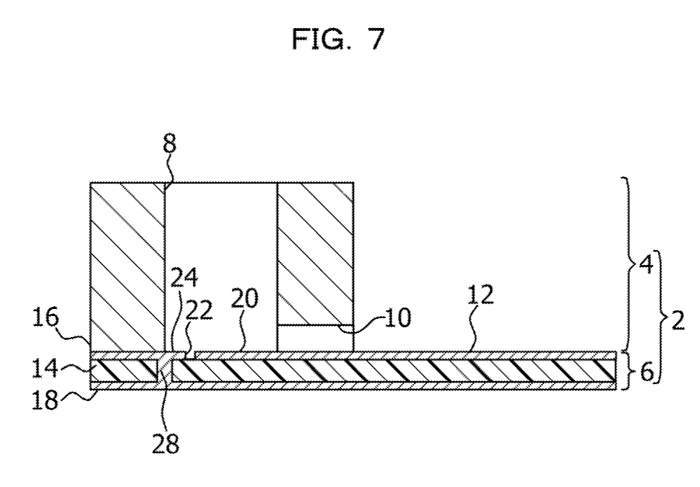

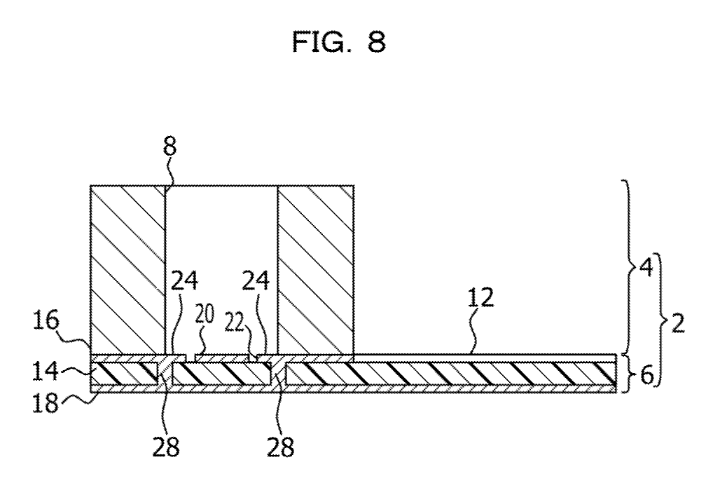

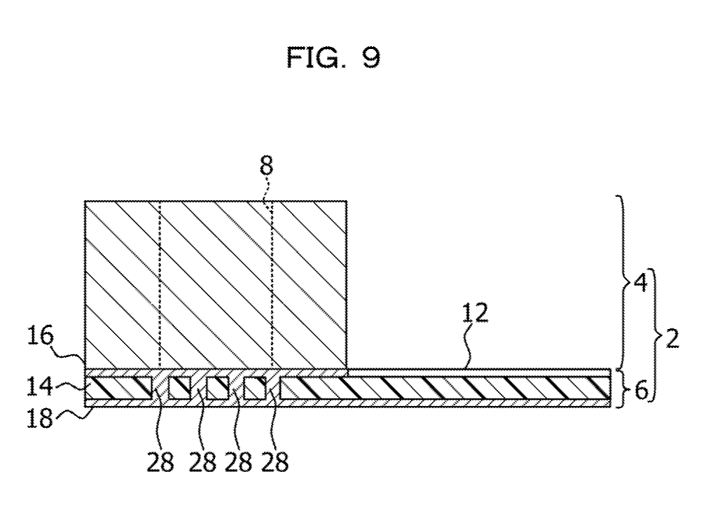

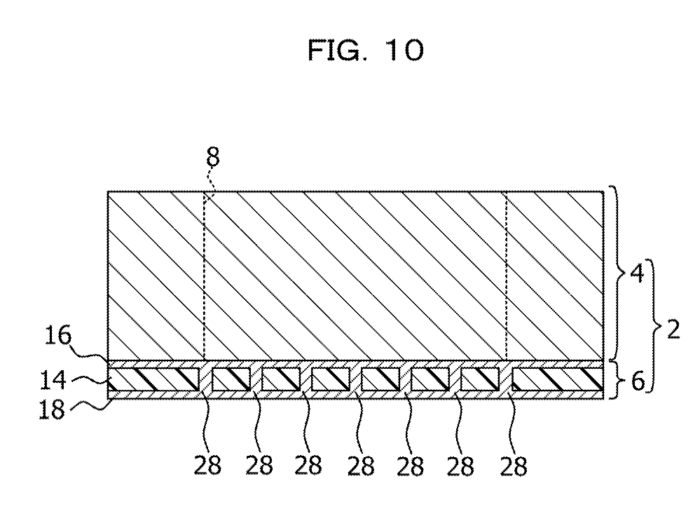

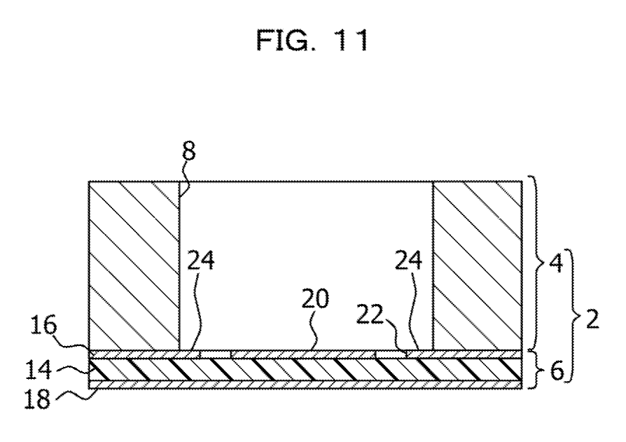

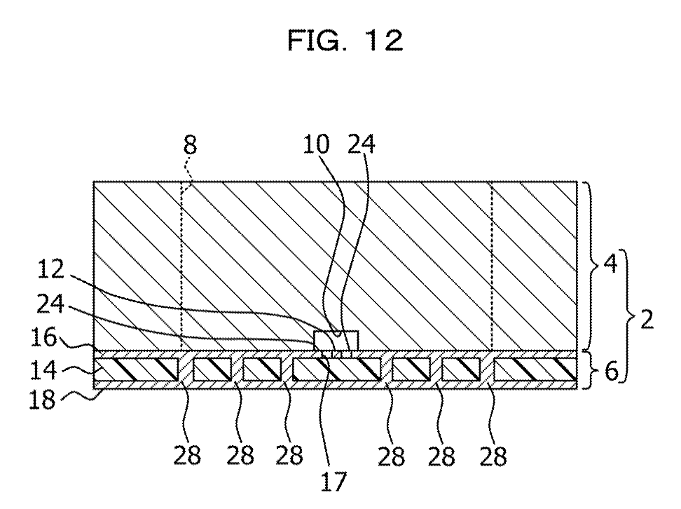

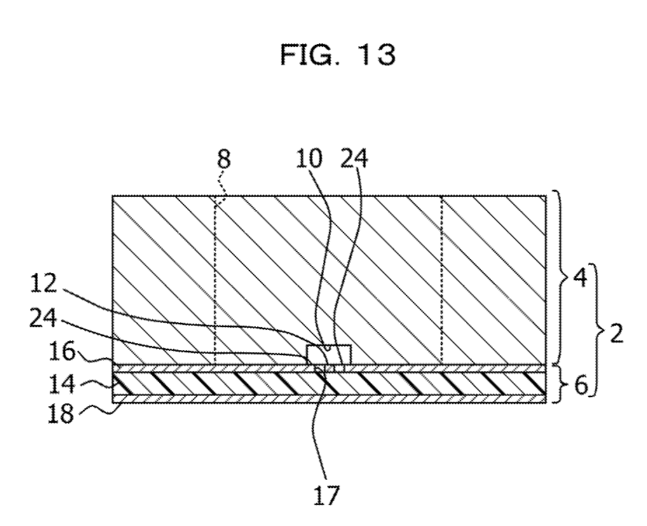

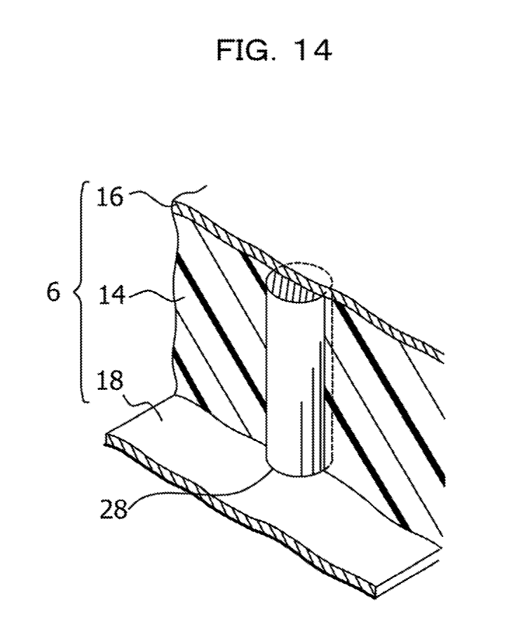

The waveguide converter 2 will be described with reference to FIGS. 7, 8, 9, 10, 11, 12, and 13. FIG. 7 is a cross-sectional view taken along the line VII-VII of FIG. 5. FIG. 8 is a cross-sectional view taken along the line VIII-VIII of FIG. 5. FIG. 9 is a cross-sectional view taken along the line IX-IX of FIG. 5. FIG. 10 is a cross-sectional view taken along the line X-X of FIG. 5. FIG. 11 is a cross-sectional view taken along the line XI-XI of FIG. 5. FIG. 12 is a cross-sectional view taken along the line XII-XII of FIG. 5. FIG. 13 is a cross-sectional view taken along the line XIII-XIII of FIG. 5. As is clear from the cross-sectional views, the circuit substrate 6 is provided with the plurality of ground vias 28 which penetrate through the insulated substrate 14. The ground vias 28 are provided along the extension of the hollow portion 8 of the waveguide 4. In other words, the ground vias 28 surround the hollow portion 8. As illustrated in FIG. 14, each ground via 28 penetrates through the insulated substrate 14 to connect the ground conductor 16 and the ground conductor 18. FIG. 14 illustrates the circuit substrate 6 cut at a ground via 28.

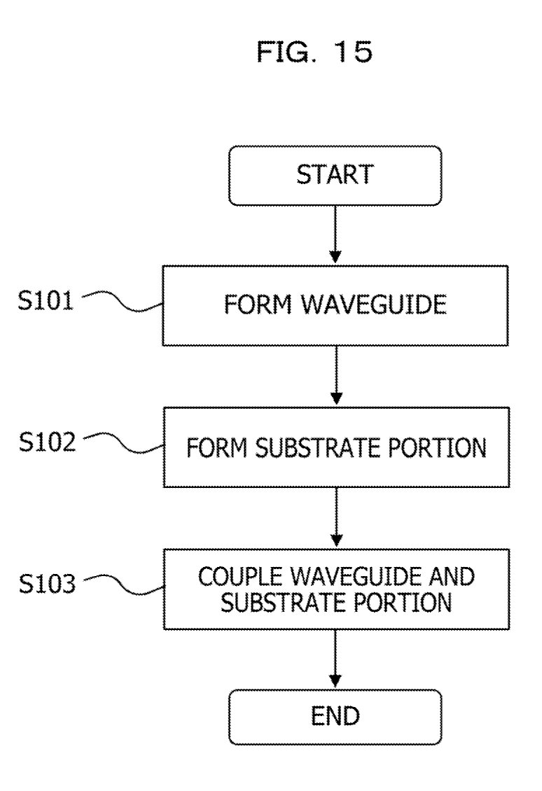

Next, a manufacturing method for the waveguide converter will be described with reference to FIG. 15. FIG. 15 is a flowchart illustrating an exemplary manufacturing method for the waveguide converter.

The manufacturing process is an example of the manufacturing method according to the present disclosure. As illustrated in FIG. 15, the manufacturing method includes forming a waveguide 4 (step S101), forming a circuit substrate 6 serving as a substrate portion (step S102), and coupling the waveguide 4 and the circuit substrate 6 (step S103).

In the formation of a waveguide 4 (step S101), the waveguide 4 discussed above is formed. As illustrated in FIG. 4, the waveguide 4 is formed with a port portion 10 at the lower end of a wall portion of a rectangular tube.

In the formation of a circuit substrate 6 (step S102), the circuit substrate 6 discussed above is formed. The circuit substrate 6 includes an insulated substrate 14, a ground conductor 16 formed on the front surface of the insulated substrate 14, and a ground conductor 18 formed on the back surface of the insulated substrate 14. The ground conductors 16 and 18 may be a conductor layer made of a metal conductor formed by a coating formation method such as plating or vapor deposition. The ground conductor 16 and the ground conductor 18 are connected by ground vias 28 formed by drilling the insulated substrate 14, for example.

The ground conductor 16 is formed with a gap portion 17 and an opening portion 22. A patch conductor 20 is formed in the opening portion 22. A signal line 12 is formed on a portion of the exposed surface portion 19 of the insulated substrate 14. The signal line 12 is connected to the patch conductor 20, and extends from the opening portion 22 through the gap portion 17. The signal line 12 may be a conductor layer made of a metal conductor formed by a coating formation method such as plating or vapor deposition, as with the ground conductors 16 and 18.

In the coupling of the waveguide 4 and the circuit substrate 6 (step S103), the waveguide 4 is mounted on the ground conductor 16 provided on the upper surface of the circuit substrate 6 discussed above to obtain the waveguide converter 2 discussed above.

The characteristics of the waveguide converter 2 according to the above embodiment are listed as follows.

(1) In the thus configured waveguide converter 2, a signal transmitted from the signal line 12 enters into the waveguide 4 by way of the coplanar line 26, and is radiated from the patch conductor 20 to the hollow portion 8 of the waveguide 4 as an electromagnetic wave. That is, the high-frequency signal is converted into a waveguide mode propagating from the patch conductor 20 through the hollow portion 8 of the waveguide 4, and is propagated through the waveguide 4.

Also, an electromagnetic wave propagating through the hollow portion 8 of the waveguide 4 is guided to the patch conductor 20, and is propagated from the waveguide 4 to the signal line 12 by way of the patch conductor 20 and then the coplanar line 26. A waveguide mode is thus converted into a signal propagating through the signal line 12.

(2) In the waveguide converter 2, the opening area of the opening portion 22 of the ground conductor 16 is small compared to the opening area of the waveguide 4. No signal line vias are formed on the signal line 12, and the signal line 12 and the patch conductor 20 are provided on the same surface of the insulated substrate 14. In addition, the port portion 10 has a width that is smaller than a length corresponding to half (=λ/2) the wavelength λ of the frequency of use f. The waveguide 4 on the patch conductor 20 side is continuous with the ground conductor 16, and the opening of the waveguide 4 is closed by the ground conductor 18 which is connected to the ground conductor 16 by the ground vias 28. The waveguide 4 is closed by the port portion 10 formed in a side surface of the waveguide 4. Thus, it is possible to prevent a waveguide mode from leaking out from the circuit substrate 6.

In the waveguide converter 2, further, the signal line 12 serving as a signal line pattern and the ground conductor 16 serving as a ground pattern are provided on the upper-surface side of the circuit substrate 6, the ground conductor 18 serving as a ground pattern is provided on the lower-surface side of the circuit substrate 6, and the ground conductors 16 and 18 are connected by the ground vias 28. In addition, the hollow portion 8 of the waveguide 4 is surrounded by the ground vias 28. Thus, an input signal from the signal line 12 enters into the coplanar line 26, and is radiated from the patch conductor 20 to the hollow portion 8 of the waveguide 4. However, no vias are provided on the signal line 12. Therefore, although signal line vias provided on the signal line 12 may degrade the conversion characteristics unless such vias were provided by forming holes accurately, the configuration in which no signal line vias are provided on the signal line does not cause such an inconvenience.

(3) The signal line 12 and the patch conductor 20 are formed on the same surface of the insulated substrate 14, and in addition, the opening portion 22 of the ground conductor 16 is configured to have a small opening area compared to the waveguide 4. This contributes to preventing a waveguide mode from leaking out from the circuit substrate 6.

(4) The gaps between the ground vias 28 have a width e (FIG. 6) that is smaller than a length corresponding to half (=λ/2) the wavelength λ of the frequency of use f. This contributes to preventing a waveguide mode from leaking out from the circuit substrate 6.

(5) The port portion 10 of the waveguide 4 is configured to have an opening width c₁, which is smaller than half (=λ/2) the wavelength λ of the frequency of use f. This contributes to preventing a waveguide mode from leaking out from the port portion 10.

(6) The hollow portion 8 of the waveguide 4 is configured to have opening widths a₁ and b₁, and the opening portion 22 of the ground conductor 16 is configured to have opening widths a₂ and b₂, which are smaller than the opening widths a₁ and b₁ in order to provide for the overreaching portion 24. Therefore, as is clear from the formulas (1) and (2) discussed above, the hollow portion 8 of the waveguide 4 may be displaced within ±Δa₁₂=(a₁−a₂)/2 in the left-right direction and ±Δb₁₂=(b₁−b₂)/2 in the up-down direction with reference to the center O to obtain the same conversion characteristics.

(7) According to the configuration described above, the conversion characteristics are not affected by the positional accuracy of the waveguide 4 with respect to the circuit substrate 6. The conversion characteristics are not affected by the distance to the short-circuit plane between the waveguide 4 and the ground conductor 16 of the circuit substrate 6. A high processing accuracy is not required, which reduces the cost. In addition, no signal line vias are provided. Although a high pattern position accuracy is not required for the ground conductors 16 and 18 provided on the circuit substrate 6, a waveguide mode is not likely to leak out. Thus, in the waveguide converter 2, the conversion characteristics are not affected by positional (dimensional) variations caused in manufacture. With the conversion characteristics not affected by the positional accuracy and without the need for a high positional accuracy or a high processing accuracy, a resin substrate which is inexpensive may be used as the circuit substrate 6, which allows cost reduction.

### Second Embodiment

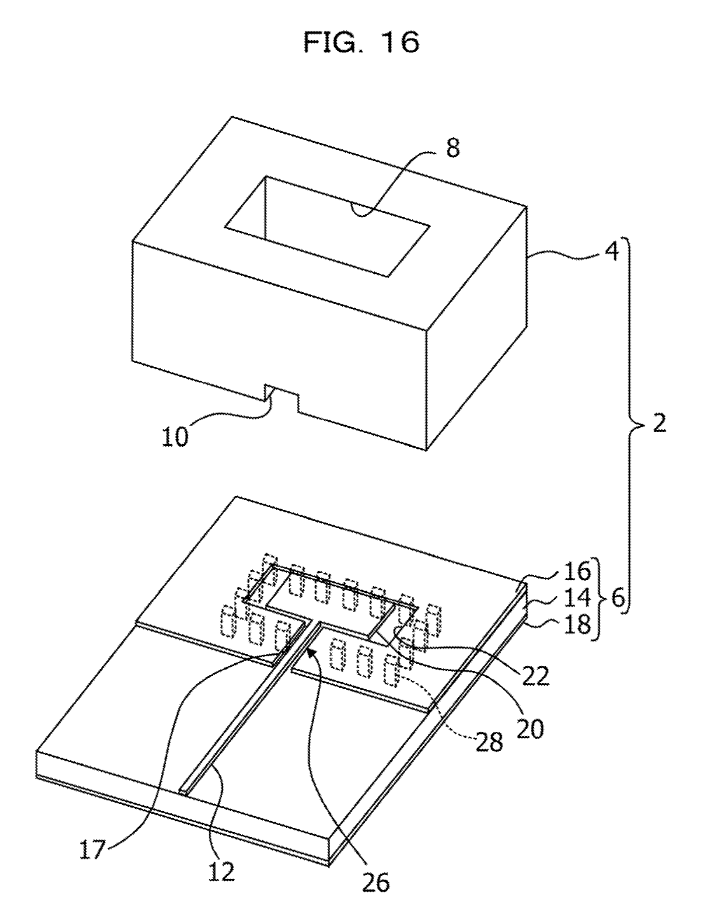

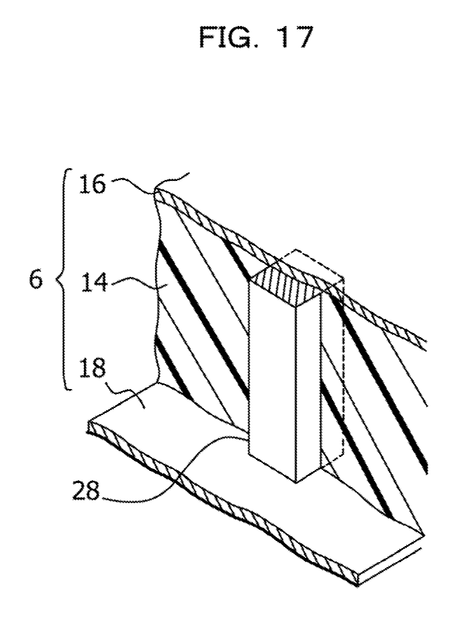

In a second embodiment, the ground vias 28 according to the first embodiment are configured to have a rectangular shape. In the second embodiment, as illustrated in FIGS. 16 and 17, the rectangular ground vias 28 are disposed in the same way as the first embodiment. Such a configuration is also expected to provide a substantially similar effect as that of the first embodiment. FIG. 16 is an exploded perspective view illustrating an exemplary waveguide converter according to the second embodiment, in which the waveguide and the circuit substrate are separated from each other. FIG. 17 illustrates the circuit substrate 6 cut at a ground via 28.

### Third Embodiment

In a third embodiment, a continuous ground pattern is provided in place of the plurality of ground vias 28 according to the first embodiment.

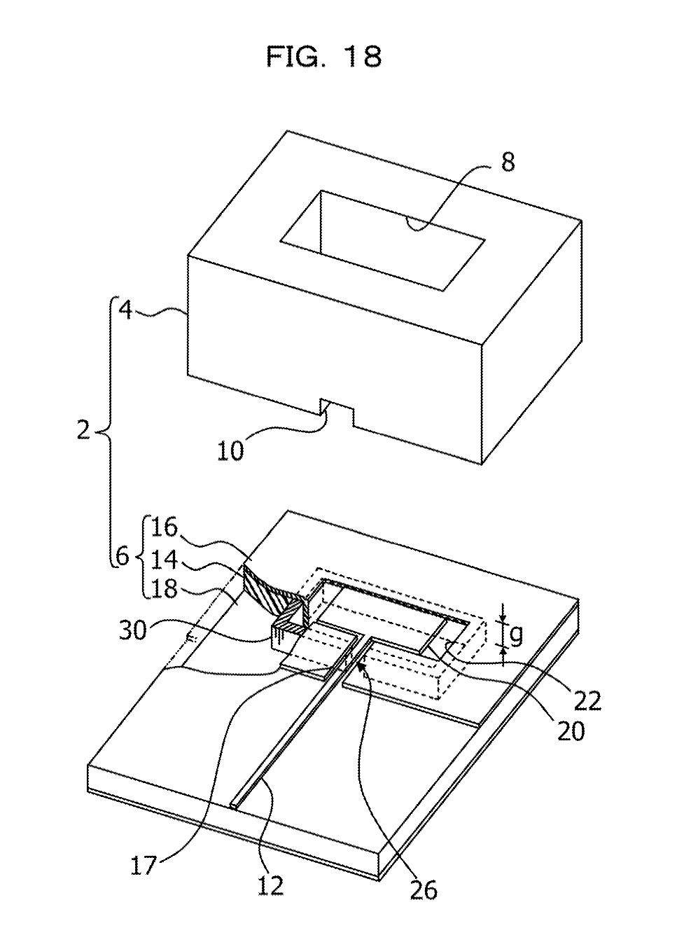

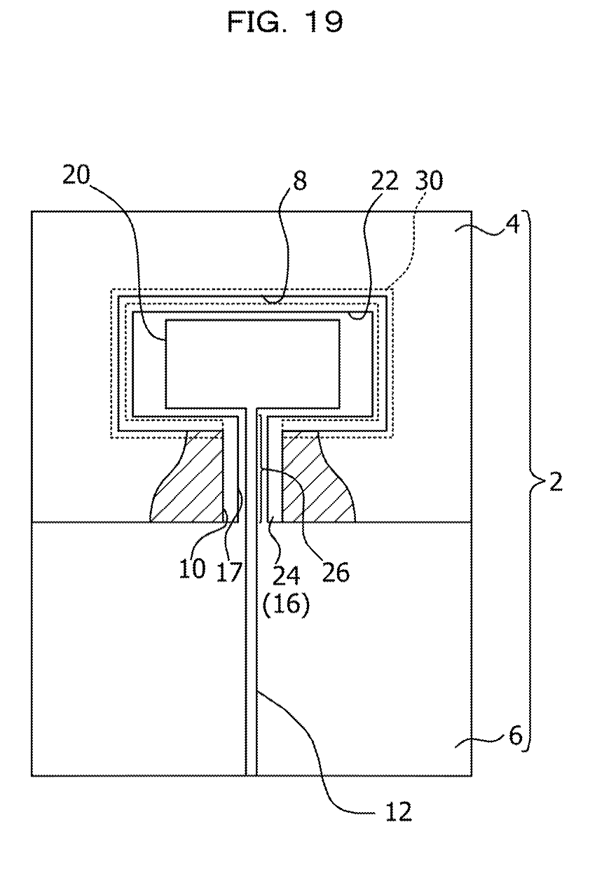

The third embodiment will be described with reference to FIGS. 18 and 19. FIG. 18 is an exploded perspective view illustrating a waveguide converter according to the third embodiment. FIG. 19 illustrates the waveguide converter as seen from the upper-surface side (waveguide side) with the port portion cut away. The configuration illustrated in FIGS. 18 and 19 is exemplary, and the present invention is not limited to such a configuration.

While the ground conductor 16 and the ground conductor 18 are connected by the plurality of ground vias 28 (FIGS. 4, 14, 16, and 17) on the insulated substrate 14 in the above embodiments, a ground pattern portion 30 is provided to connect the ground conductors 16 and 18 in the embodiment as illustrated in FIGS. 18 and 19. The ground pattern portion 30 is a C-shaped pattern connection portion provided to penetrate through the insulated substrate 14. Therefore, the ground pattern portion 30 has a height g which is the same as that of the insulated substrate 14. The ground pattern portion 30 is formed with a gap portion 17.

In the waveguide converter 2 according to the embodiment, conductor patterns such as the signal line 12 and the ground conductor 16 are formed on the upper-surface side of the insulated substrate 14, and the ground conductor 18 is formed on the lower-surface side of the insulated substrate 14. The ground pattern portion 30 surrounds the opening of the hollow portion 8 of the waveguide 4 as with the ground vias 28 discussed above. Such a configuration also provides a substantially similar effect as that of the above embodiments.

### Fourth Embodiment

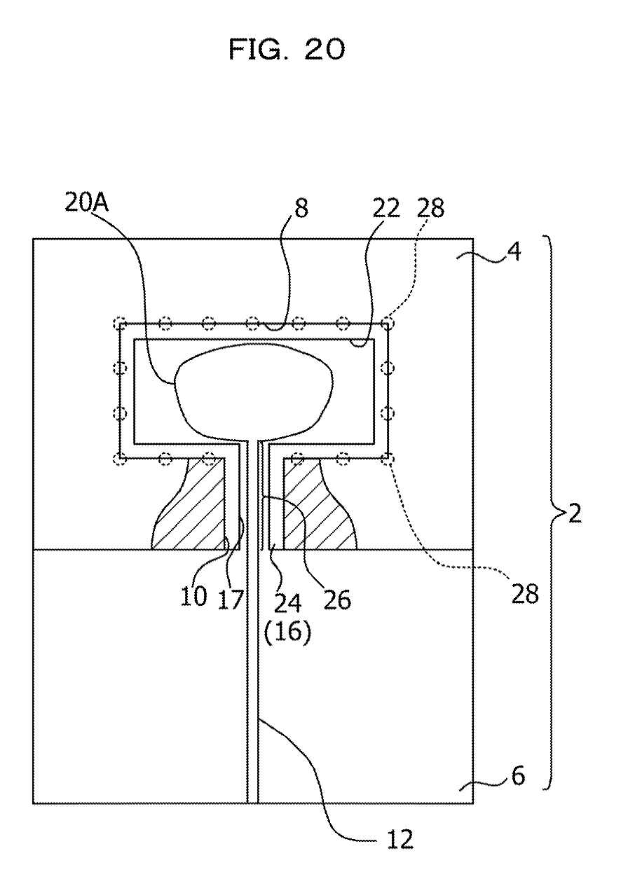

A fourth embodiment relates to a modification of the patch. In the fourth embodiment, as illustrated in FIG. 20, a patch conductor 20A in the shape similar to that of a silkworm cocoon that is substantially symmetrical in the left-right direction is provided inside the opening portion 22 of the ground conductor 16. Such a configuration is also expected to provide a substantially similar effect as that of the above embodiments.

### Fifth Embodiment

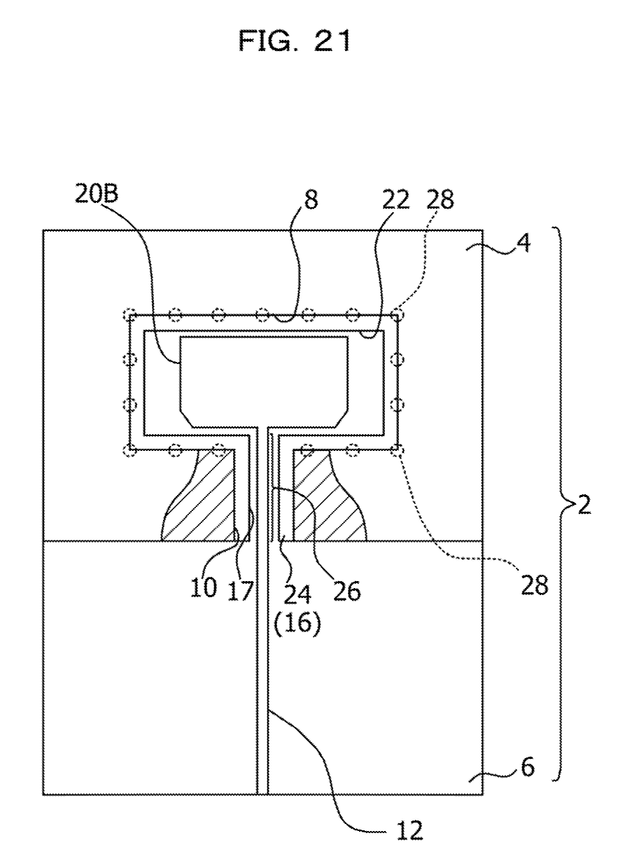

A fifth embodiment relates to a modification of the patch. In the fifth embodiment, as illustrated in FIG. 21, a patch conductor 20B in the shape of a hexagon obtained by cutting off corners of the patch conductor 20 on the signal line 12 side is provided inside the opening portion 22 of the ground conductor 16. Such a configuration is also expected to provide a substantially similar effect as that of the above embodiments.

### Sixth Embodiment

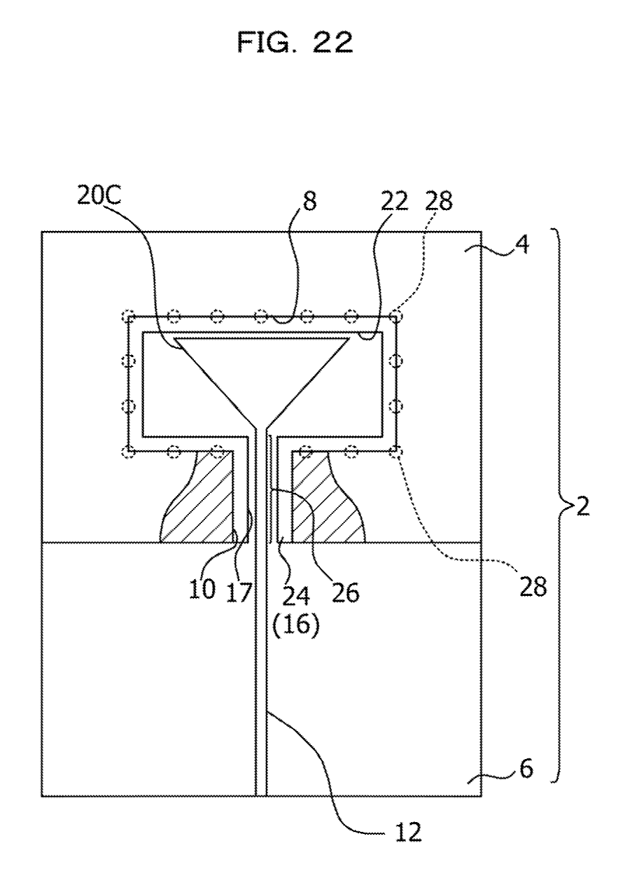

A sixth embodiment relates to a modification of the patch. In the sixth embodiment, as illustrated in FIG. 22, a patch conductor 20C in the shape of a triangle that is symmetrical in the left-right direction with its vertex angle on the port portion 10 side is provided inside the opening portion 22 of the ground conductor 16. Such a configuration is also expected to provide a substantially similar effect as that of the above embodiments.

### Seventh Embodiment

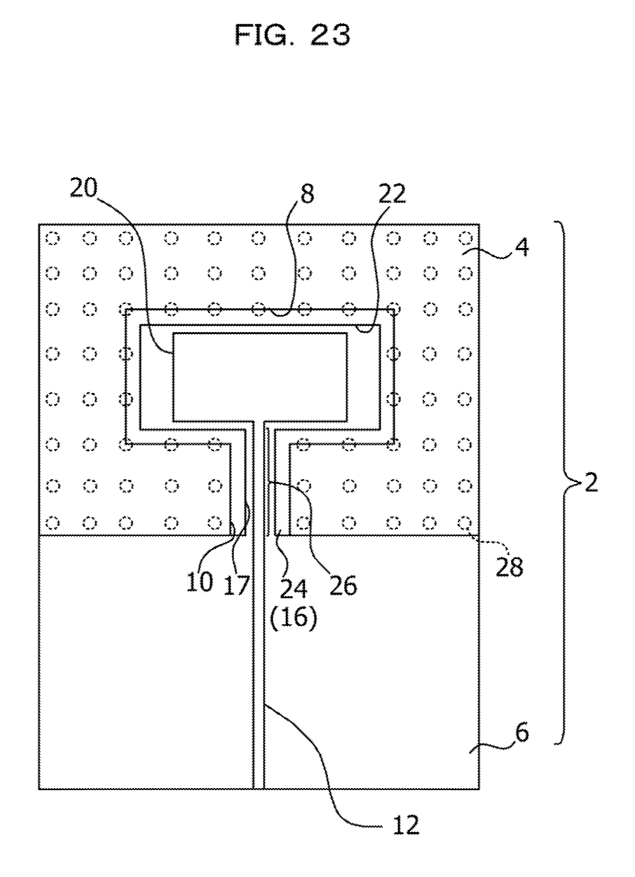

A seventh embodiment relates to a modification of the ground vias. In the seventh embodiment, as illustrated in FIG. 23, a large number of ground vias 28 are provided through the insulated substrate 14 to couple the ground conductor 16 and the ground conductor 18. Such a configuration is also expected to provide a substantially similar effect as that of the above embodiments.

### Eighth Embodiment

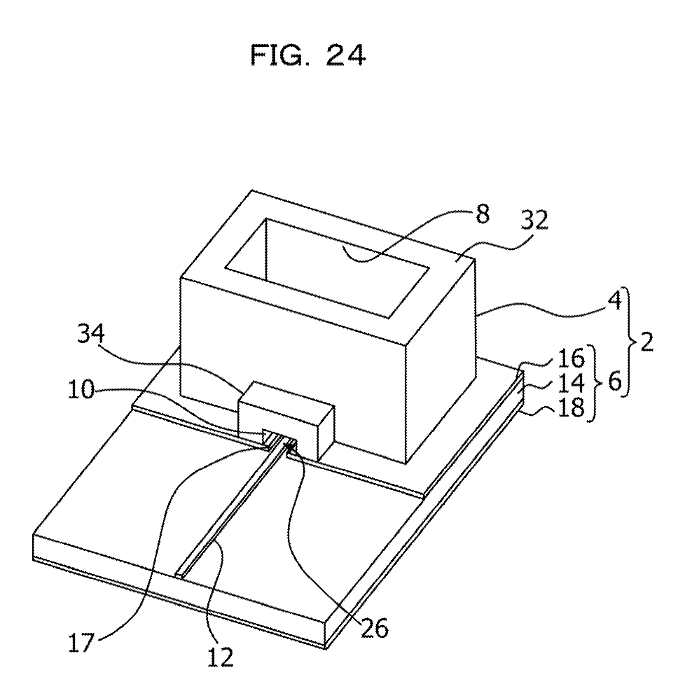

An eighth embodiment relates to a modification of the waveguide portion. While the outer shape of the waveguide 4 conforms to the shape of the ground conductor 16 in the above embodiments, the waveguide 4 is configured to be smaller than the ground conductor 16 in the eighth embodiment as illustrated in FIG. 24, with the hollow portion 8 of the waveguide 4 configured in the same way as the above embodiments. In this case, a conductor portion 32 of the waveguide 4 is configured to be thin. Thus, a projecting portion 34 may be formed to surround the port portion 10 so that the projecting portion 34 which is integral with the waveguide 4 covers the coplanar line 26 in the same way as the above embodiments. Such a configuration is also expected to provide a substantially similar effect as that of the above embodiments.

### Ninth Embodiment

A ninth embodiment provides a radar device that uses the waveguide converter discussed above.

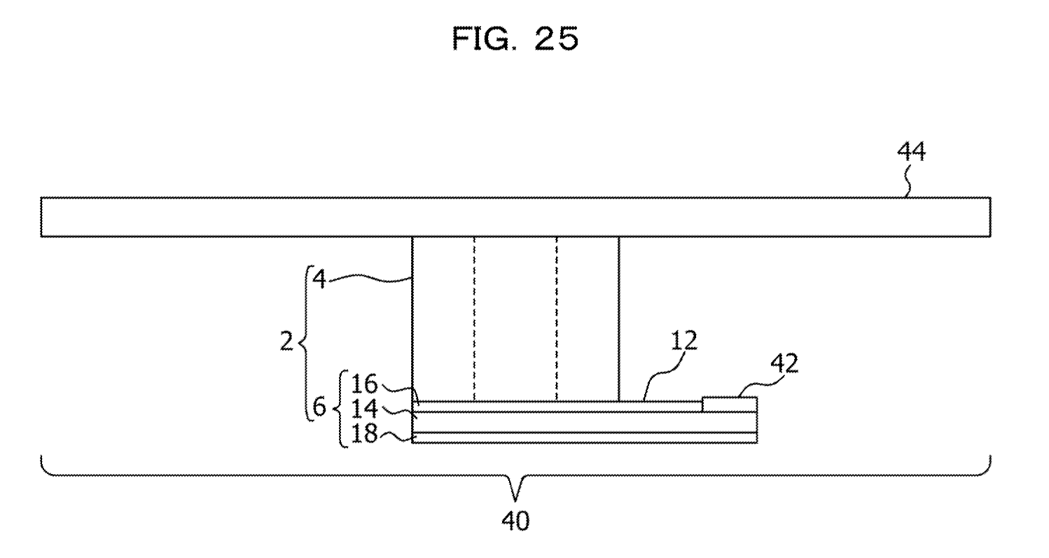

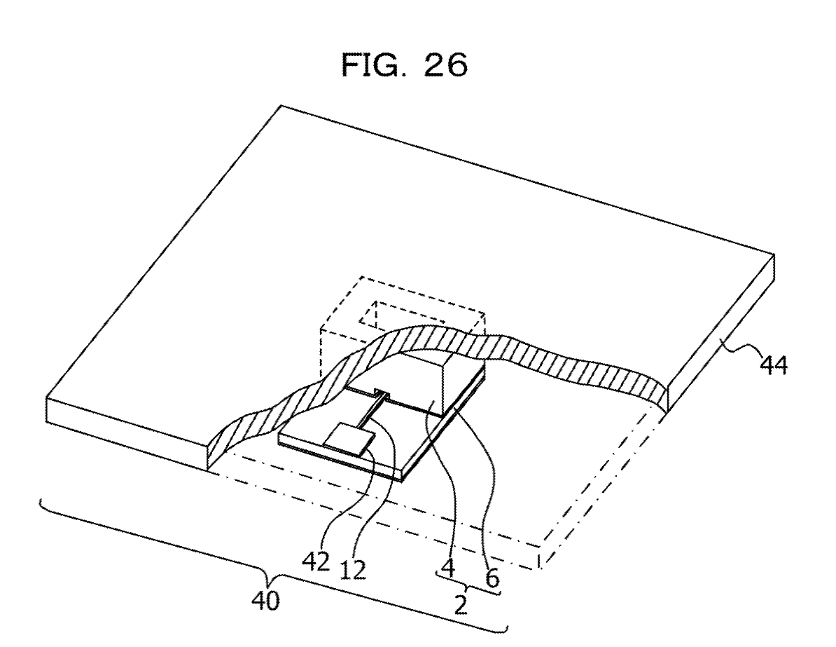

The radar device will be described with reference to FIGS. 25 and 26. FIG. 25 illustrates a radar device according to the ninth embodiment. FIG. 26 illustrates the radar device with an antenna partially cut away. The configuration illustrated in FIGS. 25 and 26 is exemplary, and the present invention is not limited to such a configuration. Components in FIGS. 25 and 26 that are the same as those in FIG. 1 are denoted by the same reference numerals.

As illustrated in FIGS. 25 and 26, a radar device 40 includes an RF section 42 that is provided on the circuit substrate 6 of the waveguide converter 2 discussed above and that is connected to the signal line 12 discussed above. The RF section 42 is an example of a transmission/reception section for millimeter waves, and may be formed by a monolithic microwave integrated circuit (MMIC), for example. An antenna 44 is provided on top of the waveguide 4.

According to such a configuration, it is possible to provide a radar device 40 with excellent conversion characteristics achieved by effectively utilizing the conversion characteristics of the waveguide converter 2 discussed above.

### Simulation Results

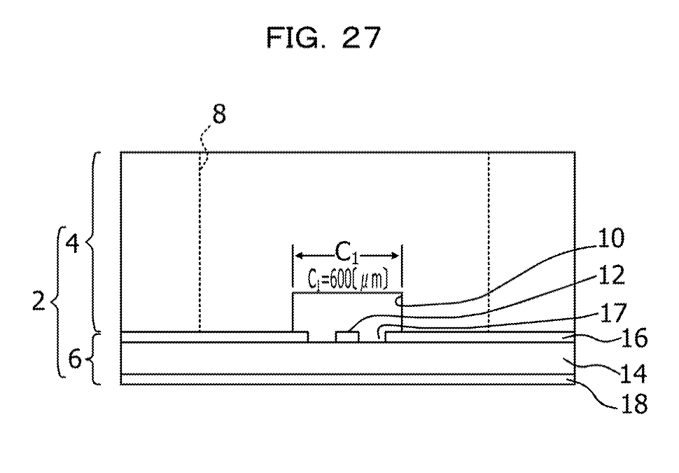

A simulation performed using the waveguide converter according to the present disclosure will be described with reference to FIG. 27. FIG. 27 illustrates a waveguide converter used in the simulation. The waveguide converter illustrated in FIG. 27 is exemplary, and the waveguide converter according to the present disclosure is not limited to such a configuration.

In the simulation, a resin waveguide converter in which the insulated substrate 14 of the circuit substrate 6 was made of a resin was used. In the resin waveguide converter, the opening width c₁ of the port portion 10 was set to 600 [μm].

According to the simulation, a waveguide mode leaked out significant when the opening width c₁ of the port portion 10 was larger than half (=λ/2) the wavelength λ of the frequency of use f.

The waveguide converter and the manufacturing method for the waveguide converter according to the present disclosure are widely applicable to waveguide converters for automotive radars used in a millimeter-wave frequency band or the like, and are thus useful.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A waveguide converter that performs signal conversion for a substrate-side line, comprising:
a waveguide configured with an opening;
a patch disposed inside the opening of the waveguide;
a first ground conductor provided substantially along the opening of the waveguide; and
a port that opens in a side surface of the waveguide through which a signal line connected to the patch extends.

2. The waveguide converter according to claim 1, further comprising:
a substrate provided on a side of the opening of the waveguide, the substrate including the first ground conductor, an insulated substrate, and a second ground conductor.

3. The waveguide converter according to claim 1,
wherein the first ground conductor is provided to extend into the opening of the waveguide.

4. The waveguide converter according to claim 2,
wherein the first ground conductor is connected to the second ground conductor provided on a back-surface side of the insulated substrate by at least one connection portion penetrating through the insulated substrate.

5. The waveguide converter according to claim 1,
wherein the patch is formed on the same plane as the first ground conductor.

6. The waveguide converter according to claim 1,
wherein the patch is configured to be smaller than an area of the opening of the waveguide.

7. The waveguide converter according to claim 1,
wherein the patch has a shape that is analogous to a shape of the opening of the waveguide.

8. The waveguide converter according to claim 1,
wherein the patch has a shape that is different from a shape of the opening of the waveguide.

9. The waveguide converter according to claim 1,
wherein the port has an opening width that is smaller than half a wavelength of a frequency of use.

10. The waveguide converter according to claim 1,
wherein the port is hole or a groove that opens in a side surface of the waveguide.

11. The waveguide converter according to claim 1,
wherein the port is hole or a groove that opens in a side surface of the waveguide, and the first ground conductor extends into the port.

12. The waveguide converter according to claim 2,
wherein the first ground conductor is interposed between the waveguide and the insulated substrate.

13. A manufacturing method for a waveguide converter that performs signal conversion for a substrate-side line, the manufacturing comprising:
forming a waveguide including a port;
forming a substrate with a ground conductor, a patch, and a signal line; and
mounting the waveguide portion on the substrate.
